(19) United States
(12) Patent Application Publication
(10) Pub. No.: US 2022/0405635 A1
(43) Pub. Date: Dec. 22, 2022

(54) MACHINE LEARNING ENGINE IMPLEMENTATION METHOD AND APPARATUS, TERMINAL DEVICE, AND STORAGE MEDIUM

(71) Applicant: ZTE Corporation, Shenzhen (CN)

(72) Inventor: Dongming ZHANG, Shenzhen (CN)

(21) Appl. No.: 17/600,952

(22) PCT Filed: Apr. 20, 2020
(86) PCT No.: PCT/CN2020/085623

§ 371 Date: Mar. 16, 2022

(30) Foreign Application Priority Data
May 30, 2019 (CN) 201910463945.X

(51) Int. Cl. G06N 20/00; G06Q 10/04

(52) U.S. Cl. CPC G06N 20/00; G06Q 10/04

(57) ABSTRACT

A method for implementing a machine learning engine and apparatus, a terminal device (50), and a storage medium (60) are disclosed. The apparatus may include: a core learning application module (101) with an independent application process and a prediction output service module (102) located in the system process (100); the core learning application module (101) is configured to output a prediction result generated by machine learning to the prediction output service module (101); and the prediction output service module (102) is configured to buffer the prediction result when receiving the predictions result sent by the core learning application module (101).

### CROSS-REFERENCE TO RELATED APPLICATION

This application is a national stage filing under 35 U. S.C. § 371 of international application number PCT/CN2020/085623, filed Apr. 20, 2020, which claims priority to Chinese patent application No.201910463945.X, filed on May 30, 2019. The contents of these applications are incorporated herein by reference in their entirety.

### TECHNICAL FIELD

Embodiments of the present disclosure relate to, but are not limited to, a method and apparatus for implementing a machine learning engine, a terminal device, and a non-transitory computer-readable storage medium.

### BACKGROUND

Machine learning is a hot field of AI technology. At present, AI technologies such as machine learning are hot spots in various industries. For a long time in the future, it can be predicted that AI technology and its productization will be the technical commanding heights of fierce competition among countries and companies. In the field of mobile phone terminal products, the productization of machine learning is faced with the following limitations or special scenarios: machine learning is often computationally intensive, and data acquisition and training are time consuming. However, when machine learning is applied to system optimization and other fields, the system framework side has high real-time requirements for obtaining prediction results. Therefore, there is a necessity for improvement.

### SUMMARY

At least one embodiment of the present disclosure provides a method and apparatus for implementing a machine learning engine, a terminal device, and a non-transitory computer-readable storage medium, for improving the real-time performance of obtaining a machine learning prediction result. At least one embodiment of the present disclosure provides an apparatus for implementing a machine learning engine, which may include a core learning application module with an independent application process and a prediction output service module located in a system process, where the core learning application module is configured to output a prediction result generated by machine learning to the prediction output service module; and the prediction output service module is configured to buffer the prediction result in response to a reception of the prediction result sent by the core learning application module.

At least one embodiment of the present disclosure provides a method for implementing a machine learning engine, which may include: outputting, through a core learning application module with an independent application process, a prediction result generated by machine learning to a prediction output service module located in the system process; and buffering the prediction result through the prediction output service module.

At least one embodiment of the present disclosure provides a terminal device, which may include a memory and a processor, where the memory stores a program which, when read and executed by the processor, causes the processor to perform the method for implementing a machine learning engine according to any one of the embodiments.

At least one embodiment of the present disclosure provides a non-transitory computer-readable storage medium storing at least one program, where the eat least one program is executable by at least one processor and cause the at least one processor to perform the method for implementing a machine learning engine according to any one of the embodiments.

Other features and advantages of the present disclosure will be set forth in the description and, at least in part, will be apparent from the description or may be learned by practice of the present disclosure. The objects and other advantages of the present disclosure can be realized and obtained by the structure particularly pointed out in the specification, the appended claims and the accompanying drawings.

### BRIEF DESCRIPTION OF DRAWINGS

The accompanying drawings are used to provide a further understanding of the technical schemes of the present disclosure and form a part of the specification. The accompanying drawings, together with the embodiments of the present disclosure, are used to explain the technical schemes of the present disclosure, and should not be construed as limiting the technical schemes of the present disclosure.

FIG. 1 is a schematic block diagram of an apparatus for implementing a machine learning engine according to an embodiment of the present disclosure;

FIG. 2 is a schematic flowchart of a method for implementing a machine learning engine according to an embodiment of the present disclosure;

FIG. 3 is a schematic block diagram of a machine learning engine system according to an embodiment of the present disclosure;

FIG. 4 is a schematic block diagram of a machine learning engine system provided by a specific example of the present disclosure;

FIG. 5 is a schematic block diagram of a terminal device according to another embodiment of the present disclosure; and

FIG. 6 is a schematic block diagram of a non-transitory computer-readable storage medium according to an embodiment of the present disclosure.

### DETAILED DESCRIPTION

In order to make the object, technical schemes and advantages of the present disclosure clear, embodiments of the present disclosure will be described in detail with reference to the accompanying drawings. It should be noted that the embodiments in the present disclosure and the features in the embodiments can be combined with each other without conflict.

The steps shown in the flowcharts of the drawings may be performed in a computing system, such as a set of computer-executable instructions. Although a logical order is shown in the flowchart, in some cases, the steps shown or described may be performed in a different order.

In existing technologies, each part of machine learning is basically completed independently in one application. Based on this, if a prediction result generated by the machine learning needs to be frequently accessed by one or more system framework modules, there will be a performance problem. In addition, there are some AI products, such as face recognition and speech recognition, which usually load pre-trained models in terminal devices. In this way of AI productization, the model cannot be updated after being released, or it can only be updated and downloaded online. In the aspects of performance optimization and behavior learning of mobile devices, the habits of users of each stand-alone device are different, and there is no unified training model. The above fixed model is not suitable for these application scenarios, so it is necessary to train and optimize the stand-alone device separately. In addition, if the model is updated online, there are some problems such as user privacy leakage.

Generally, machine learning can only perform data collection, training and prediction independently on the user's mobile phone terminal, but cannot collect and return data to the server for training. In addition, although the usage habits of multiple users vary widely, the usage habits of a single user can reflect strong regularity on his mobile phone for learning, so the independent training of a stand-alone machine is often more effective.

In view of the above background, machine learning can be completed independently on mobile terminal devices, without the need for data return and model download through networking. According to the present disclosure, the prediction output service is separated and resident in the system process. This separation can shorten the access time of the system process to the machine learning model to almost negligible, and has higher real-time performance. In addition, machine learning is realized by an independent application process, so that the functions such as application upgrade and update can be independently completed.

Machine learning is computationally intensive and consumes a lot of computing resources. The software and hardware performance of mobile devices is limited. However, a system framework module has a restrict real-time demand for prediction results of machine learning models. Therefore, in at least one embodiment of the present disclosure, it is intended to implement a stand-alone machine learning engine on the mobile terminal device, which can independently realize data collection, training and prediction on the stand-alone device. At the same time, in order to output a prediction result to other system modules of the equipment in real time and efficiently, the machine learning engine is divided into two parts: the core learning application module and the prediction output service module. The core learning application module has an independent application process, that is, machine learning (including data collection, storage, model training, prediction and other functions) is independently completed in an independent application process to obtain the prediction result. The prediction output service module resides in the system process and buffers the prediction result obtained by machine learning of the core learning application module. Because the prediction output service resides in the system process, other modules in the system process can directly obtain the prediction result in the process. More importantly, the prediction output service provides buffered result instead of direct calculation from scratch, so the time consumption of other modules in the system process to obtain the prediction result is almost negligible.

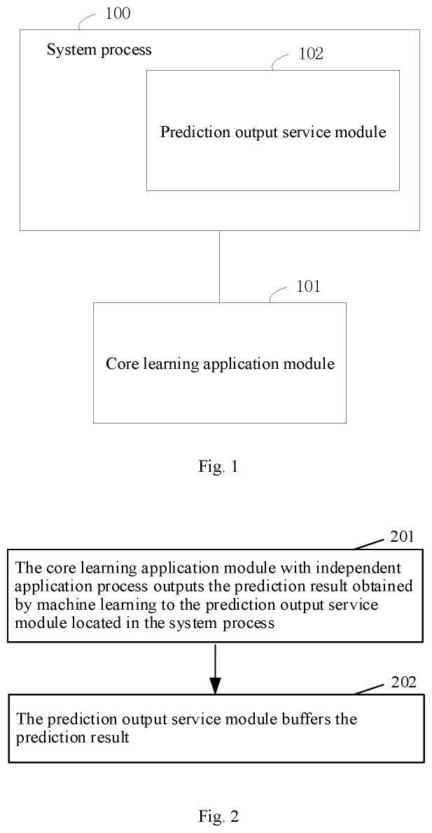

An embodiment of the present disclosure provides an apparatus for implementing a machine learning engine, which, as shown in FIG. 1, may at least include a core learning application module 101 with an independent application process and a prediction output service module 102 located in a system process 100. The core learning application module 101 is configured to perform machine learning to generate a prediction result and output the prediction result to the prediction output service module 102. The machine learning can at least include data acquisition, storage, model training, prediction and so on.

The prediction output service module 102 is configured to receive the prediction result sent by the core learning application module 101 and to buffer the prediction result.

There are usually system processes and application processes running in a terminal device. A built-in system process is an essential part of the operating system, which is usually used to manage the terminal device and application processes, and provide basic functions for accessing the terminal device. The system process usually resides in memory, an abnormal exit of the system process may cause the terminal device to be unable to be used normally. An application process refers to a process by which an application program runs in the terminal device, which is independent of the system process. An application may be pre-installed on the operating system of the terminal device when it leaves the factory, or may be installed by the user.

According to the technical scheme provided in this embodiment, by separating the prediction result output from machine learning, where the prediction output service module 102 is placed in the system process, the prediction result can be output to other modules in the system process in real time and efficiently, and the user experience can be improved.

The core learning application module 101 can output a prediction result to the prediction output service module 102 through a cross-process call. A cross-process call is made, for example, through an AIDL interface.

In an embodiment, the prediction output service module 102 is further configured to buffer a validity period of the prediction result. In an embodiment, the prediction output service module 102 can acquire the validity period of the prediction result from the core learning application module 101, or the validity period of the prediction result can be set by the prediction output service module 102 independently. For example, when the core learning application module 101 writes the prediction result into the prediction output service module 102, the prediction result includes the validity period of the prediction result. Alternatively, when the prediction output service module 102 obtains the prediction result, the prediction output service module 102 independently records the prediction time and sets a duration of the prediction validity period as the validity period information. In an embodiment, the validity period can be identified by the predicted time and the duration of the validity period. In another embodiment, the validity period is directly recorded, so that the prediction result is effective before the validity period expires, and if the validity period expires, the prediction result is invalid. It should be noted that in other embodiments, the validity period may not be recorded.

In an embodiment, when a preset specific event occurs (for example, a specific application is installed, run or uninstalled; screen off; switching to flight mode; other scenarios/situations that may require mandatory update, such as a specific period of time), the prediction output service module 102 may forcibly update the validity period information of the buffered prediction result or clear the buffered prediction result. It should be noted that the above are only examples and can be set as required.

In an embodiment, the prediction output service module 102 is further configured to return the buffered prediction result to other modules in the system process when receiving requests from other modules. Other modules in the system process can access the prediction result buffered by the prediction output service module 102 at high speed through an in-process call. Because the buffered result is directly obtained from the prediction output service module 102 in the system process, there is no complicated calculation of cross-process access and machine learning, and the real-time performance is high.

In an embodiment, when the prediction output server module 102 receives requests from other modules in the system process and the prediction result is within the validity period, the prediction output server module 102 returns the buffered prediction result to the other modules. When the prediction result is not within the validity period, empty information can be returned to other modules. Alternatively, the prediction result and validity period can be returned to other modules for independent judgment by other modules. If the prediction result received by other modules is within the validity period, the prediction result can be directly used. If the received prediction result has expired, it will be treated as “no prediction result”. In addition, when the prediction result is not within the validity period, the prediction output service module 102 informs the core learning application module 101 to update the prediction result, that is, to conduct a new machine learning.

In an embodiment, the prediction output service module 102 is further configured to send an update notification according to a preset policy to inform the core learning application module 101 to perform new machine learning. Alternatively, the prediction output service module 102 is configured to notify, at a specific clock frequency, the core learning application module 101 to perform new machine learning.

The core learning application module 101 is further configured to, after receiving the update notification from the prediction output service module 102, start a new round of machine learning operation and output the updated prediction result to the prediction output service module 102. The new round of machine learning operation includes data re-acquisition, training and prediction. It should be noted that the core learning application module 101 can also update the prediction result independently. For example, when the core learning application module 101 detects that the prediction result of the local buffer is not within the validity period, it performs machine learning and updates the prediction result.

In an embodiment, the preset strategy includes at least one of the following: the end of a periodic interval, the occurrence of a preset event, or the detection that the validity period of the buffered prediction result has expired. The periodic interval can be a fixed periodic interval or a dynamically variable periodic interval. The preset event includes screen-on, unlocking, returning to the desktop, starting a specific application, and so on.

In an embodiment, the prediction output service module 102 is further configured to send an update stop notification in a target scenario to inform the core learning application module 101 to stop machine learning. The target scenario can be set according to needs, for example, the user does not currently use the terminal device, and the current CPU occupation of the terminal device exceeds a certain proportion. The target scenario can also include screen off, flight mode, game running, etc.

The core learning application module 101 is further configured to stop machine learning after receiving the update stop notification from the prediction output service module 102.

In an embodiment, the core learning application module 101 is further configured to send a prediction result to a third-party application when receiving a request for the prediction result from the third-party application. The third-party application accesses the core learning application module 101 through a cross-process mechanism. When the core learning application module 101 has the prediction result required by the third-party application, it sends the prediction result to the third-party application. The third-party application is an application of a non-system process and a non-core learning application module on the terminal device, that is, one of other applications except the core learning application module 101 in the application process.

In an embodiment, the configuration of sending the prediction result to the third-party application when the core learning application module 101 receives a request for a prediction result from a third-party application, includes the following operations.

When the core learning application module 101 receives a request from a third-party application, it performs new machine learning to generate a prediction result, and sends the updated prediction result to the third-party application.

Alternatively, when the core learning application module 101 receives a request from a third-party application, it obtains the buffered prediction result, and when the buffered prediction result is within the validity period, it returns the buffered prediction result to the third-party application. However, when the buffered prediction result is not within the validity period, the core learning application module 101 performs new machine learning to generate a prediction result and sends the updated prediction result to the third-party application.

In an embodiment, the prediction output service module 102 is further configured to forcibly update the validity period of the prediction result or clear the prediction result when a preset specific event occurs. The preset specific event can be set as required, for example, including the installation, operation or uninstallation of a specific application, screen off, switching to flight mode, specific time period, etc.

In an embodiment, the core learning application module 101 is further configured to perform interface security authentication when interacting with the third-party application or the prediction output service module 102. The mechanisms of interface security authentication include but are not limited to signature verification, privilege verification, secret key verification and other security verification mechanisms.

An embodiment of the present disclosure provides a method for implementing a machine learning engine, as shown in FIG. 2, which includes the following steps.

In step 201, the core learning application module 101 with an independent application process outputs a prediction result generated by machine learning to the prediction output service module 102 located in the system process.

In step 202, the prediction output service module 102 buffers the prediction result.

According to the technical scheme provided in this embodiment, by separating a prediction result output from machine learning and placing the prediction output service module 102 in the system process, the prediction result can be output to other modules in the system process in real time and efficiently, and the user experience is improved.

In an embodiment, the method further includes that the core learning application module 101 performs machine learning to generate the prediction result. In this embodiment, the core learning application module 101 performs machine learning independently, and does not need to return data to the server for training. Therefore, there is no requirement for the network environment, and there are no problems such as leakage of user privacy. Moreover, machine learning can be carried out according to users' own data, and the trained model is more accurate. It should be noted that the present disclosure is not limited to this, and can also be applied to the technical scheme of networked machine learning.

In an embodiment, the method further includes that the prediction output service module 102 buffers the validity period of the prediction result.

In an embodiment, the prediction output service module 102 obtains the validity period from the core learning application module 101, or the prediction output service module 102 independently sets the validity period.

In an embodiment, the method further includes: when the prediction output service module 102 receives a request from other modules in the system process, it returns the buffered prediction result to the other modules.

In an embodiment, returning the buffered prediction result to the other modules includes returning the buffered prediction result to the other modules when the prediction result is within the validity period.

In an embodiment, the method further includes: the prediction output service module 102 sends an update notification according to a preset policy to inform the core learning application module 101 to perform new machine learning; after receiving the update notification from the prediction output service module 102, the core learning application module 101 starts a new round of machine learning operation and outputs the updated prediction result to the prediction output service module 102.

In an embodiment, the preset strategy includes, but is not limited to, one or more of the following: the end of a periodic interval, the occurrence of a preset event, and the detection that the validity period of the buffered prediction result expires.

In an embodiment, the method further includes: when the core learning application module 101 receives a request for a prediction result from a third-party application, it sends the prediction result to the third-party application.

In an embodiment, when the core learning application module 101 receives a request of a third-party application requesting a prediction result, sending the prediction result to the third-party application includes the following steps.

When the core learning application module 101 receives a request from a third-party application, it performs new machine learning to generate an updated prediction result, and sends the updated prediction result to the third-party application.

Alternatively, when the core learning application module 101 receives a request from a third-party application, it obtains the buffered prediction result. When the buffered prediction result is within the validity period, it returns the buffered prediction result to the third-party application. When the buffered prediction result is not within the validity period, the core learning application module 101 performs new machine learning to generate an updated prediction result, and sends the updated prediction result to the third-party application.

In an embodiment, the method may further include: when a preset specific event occurs, the prediction output service module 102 forcibly updates the validity period of the prediction result, or clears the prediction result. The preset specific event can be set according to needs, for example, including: a specific application is installed, run or uninstalled, etc.; screen off, switching to flight mode, etc.; other scenarios/situations that may require forced update, such as specific time period.

In an embodiment, the method may further include performing interface security authentication when the core learning application module 101 interacts with the third-party application or the prediction output service module 102. The mechanisms of interface security authentication include but are not limited to signature verification, privilege verification, secret key verification and other security verification mechanisms.

At least one embodiment of the present disclosure can be applied to technical scenarios related to machine learning of mobile terminal devices. The engine provided by the embodiment of the present disclosure can be used as an AI intelligent center of a mobile terminal device system, and can support the productization of a plurality of sub-machine learning related services such as user behavior prediction, location awareness and system performance optimization.

By adopting the technical scheme provided by the embodiment of the present disclosure, a machine learning engine can be independently realized on the mobile terminal device, which integrates data acquisition, training, prediction and prediction result output, has the advantages of real-time and high efficiency, and can adapt to the software and hardware conditions of the mobile terminal device.

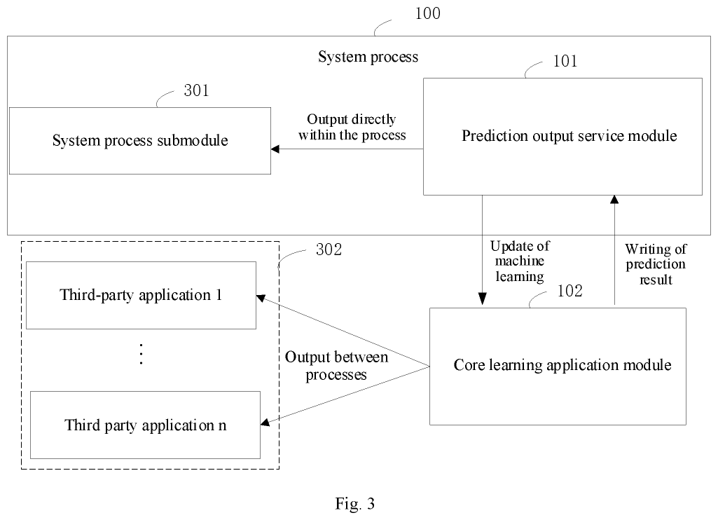

FIG. 3 is a block diagram of a machine learning system according to an embodiment of the present disclosure. As shown in FIG. 3, the machine learning system includes a core learning application module 101, a prediction output service module 102, at least one system process sub-module 301 and at least one third-party application 302.

The core learning application module 101 is an independent application running on an intelligent terminal and has its own independent process space.

The prediction output service module 102 resides in the system process and is a part of the system process.

The system process sub-module 301 is a module utilizing the prediction result of the machine learning engine, which is in the same system process space as the prediction output service module 102.

The third-party application 302 is an independent third-party application running on the intelligent terminal, which also uses the prediction result of the machine learning engine and has its own independent process space.

The core learning application module 101 realizes the main functions such as data collection, storage, model training and prediction output in its own process, and the prediction output service module 102 buffers the prediction results of various machine learning operations in the system process.

The core learning application module 101 and the prediction output service module 102 are described with reference to the aforementioned device for implementing the machine learning engine, and will not be described in detail here.

The system process sub-module 301 sends a request to the prediction output service module 102 to request the prediction result, and receives the prediction result returned by the prediction output service module 102. When the returned information carries the validity period of the prediction result, the prediction result is directly used if the prediction result is within the validity period, and it will be treated as no forecast result if the forecast result has expired. It should be noted that the returned information may not carry the validity period. The prediction output service module 102 determines the information to be returned according to whether the prediction result is within the validity period. The prediction output service module 102 returns the prediction result if it is within the validity period. If the prediction result is not within the validity period, a result of “null” or prompt information of expiration is returned, etc.

For other third-party applications 302 that are not system processes, the core learning application module 101 can be requested to obtain the prediction result through the cross- process mechanism. When the core learning application module 101 receives the prediction result request from the third-party application 302, it can directly start a new round of machine learning, return the prediction result to the third-party application 302 after the calculation is completed, and output the updated prediction result to the prediction output service module 102.

In another embodiment, when the core learning application module 101 receives a request for a prediction result sent by a third-party application 302 through a cross-process call, the core learning application module 101 can directly obtain the prediction result buffered by the prediction output service module 102, or obtain the prediction result independently buffered by the core learning application module 101. If the buffered prediction result is within the validity period, the core learning application module 101 directly returns the prediction result without new calculation. If the buffered prediction result expires, the core learning application module 101 starts a new round of calculation (updated machine learning).

As mentioned above, the core learning application module 101 completes the main functions of machine learning, such as data acquisition, storage, model training, and prediction output. The driving mode of each update of these main functions includes but is not limited to the above-mentioned explanations: a) receiving the notification from the prediction output service module 102, where the prediction output service module 102 notifies according to the preset policy; B) when receiving the request for cross-process call from the third-party application 302, start a new round of machine learning update; C) the core learning application module 101 can also update independently, for example, when it is detected that the prediction result buffered locally is not within the validity period.

In an embodiment, the interactive interface between the prediction output service module 102 and the core learning application module 101, and the interactive interface between the third-party application 302 and the core learning application module 101 are all authenticated for interface security. The interface security authentication mechanism includes but is not limited to signature verification, privilege verification, secret key verification and other security verification mechanisms. However, since the system process sub-module 301 and the prediction output service module 102 are both in the system process, the interactive interface between them may be authenticated or not authenticated, which is not limited in the present disclosure.

In order to further illustrate the present disclosure, taking Android platform as an example, an exemplary implementation based on the present disclosure is briefly introduced below.

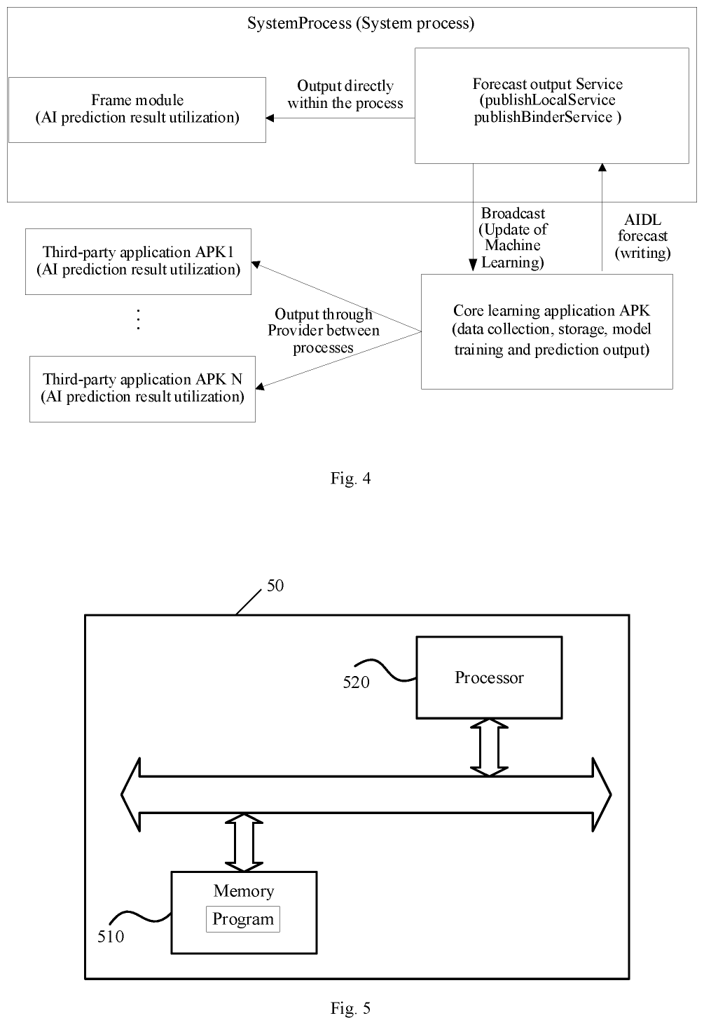

This implementation introduces some details of implementing the present disclosure in Android. The overall process is basically the same as the above description, and some details are omitted. It should be noted that the usage scenario of the present disclosure is a stand-alone product related to machine learning running on a mobile terminal device, which is not limited to a specific operating system platform or a specific service form. The following is only an example. As shown in FIG. 4, the prediction output Service is the prediction output service module, the core learning application APK is the core learning application module, the framework module is the sub-module in the system process, and the third-party applications APK1 to APK N are n third-party applications. Details are as follows.

(1) The prediction output Service is implemented on the Android system framework side. This Service is integrated in the SystemService and runs in the SystemProcess of Android platform. In the SystemProcess, the Service directly provides an internal interface related to the buffer of a prediction result of machine learning to other modules in the SystemProcess by publishLocalService. This Service provides the core learning application APK with a write interface for the prediction result in the form of AIDL by means of publishBinderService. In addition, based on a preset policy, the Service notifies the core learning application APK to update its machine learning in the form of a Broadcast component.

(2) The core learning application APK realizes the main functions of data collection, storage, model training, prediction output and so on in its process. When a prediction result needs to be output, the core learning application APK writes the prediction result into the prediction output Service by calling the AIDL interface of the prediction output Service. At the same time, the core learning application APK also provides the machine learning prediction result to the third party APK in the form of Provider component.

(3) At a fixed clock frequency and in the form of Broadcast component, the prediction output Service informs and drives the core learning application APK to perform a new round of core operations related to machine learning, such as data acquisition, storage, model training and prediction output. The core learning application APK directly protects the prediction time and validity period for each machine learning prediction result every time it outputs the prediction result. Of course, the driving mode and validity mechanism of each update of machine learning can also adopt any of the above methods.

(4) Other framework modules in the SystemProcess directly access the prediction result buffered by the prediction output Service in the SystemProcess in the above manner. When the prediction output Service checks and determines that its buffered prediction result is within the validity period, it directly returns the buffered prediction result to other framework modules; when the prediction result is overdue, “null” is directly returned as a response. Meanwhile, in some embodiments, the prediction output service notifies the core learning application APK to update machine learning in the form of Broadcast.

(5) The third-party application APK obtains relevant prediction result through the Provider component provided by the core learning application APK. After the core learning application APK receives the request for the prediction result via the Provider component, it directly starts a new round of machine learning, returns the prediction result after the calculation is completed, and simultaneously buffers the prediction result in the prediction output Service. In some embodiments, after receiving the request for prediction result via the Provider component, the core learning application APK can also access the prediction result buffered by the prediction output Service or the prediction result buffered by the core learning application APK itself, and directly return the buffered result within the validity period. If the buffered result has expired, the core learning application APK starts a new round of machine learning.

(6) The interaction between the prediction output Service and the core learning application APK, as well as the interaction between the third-party application APK and the core learning application APK, require specific interface security authentication. The authentication mechanism can adopt the authority verification mechanism of Android platform, in which different authorities with different security levels for the prediction output Service, the core learning application APK and the third-party application APK are defined, and these authorities are used to authenticate the interactive interfaces. In the process of SystemProcess, no authentication is performed between other framework modules and the prediction output Service.

The machine learning engine provided by the embodiments of the present disclosure can become an AI intelligent center of a mobile terminal device system, and supports the productization of a plurality of sub-machine learning services such as user behavior prediction, location awareness, system performance optimization and the like, which is beneficial to improving user experience. For example, based on the engine provided by the embodiment of the present disclosure, user behavior prediction can be realized. Based on such behavior prediction, services such as application recommendation, application self-starting-preloading, application self-starting-recommending can be carried out. Through these services, there will be intuitive interface changes and experience improvement. In another example, based on the engine provided by the embodiment of the present disclosure, the system performance can be automatically optimized, and the key indicators such as CPU occupancy rate, memory occupancy rate and space occupancy rate of the system can be automatically optimized, which will bring about a significant improvement in user operation fluency.

In the embodiments of the present disclosure, the prediction output service module is separated and resident in the system process, and the machine learning result is buffered by the validity mechanism, so that the access time of the system process to the prediction result of machine learning may be almost neglected, and the system process has high real-time performance. At the same time, the core learning application can independently complete independent functions such as application upgrade and update.

It should be noted that, in some embodiments, the prediction output service may not be resident in the system process, and only the dual-process buffer mode may be adopted.

At least one embodiment of the present disclosure provides a device for implementing a machine learning engine, which can be implemented on a stand-alone machine without online data transmission, thereby avoiding legal risks and improving real-time performance and efficiency. The engine is expected to develop into an AI intelligent center of mobile terminal system, which can support the productization of multiple sub-machine learning services such as user behavior prediction, location awareness and system performance optimization, and has very high commercial value.

As shown in FIG. 5, an embodiment of the present disclosure provides a terminal device 50, which includes a memory 510 and a processor 520, where the memory 510 stores a program, and when the program is read and executed by the processor 520, the processor 520 executes the steps of the method for implementing the machine learning engine described in any embodiment.

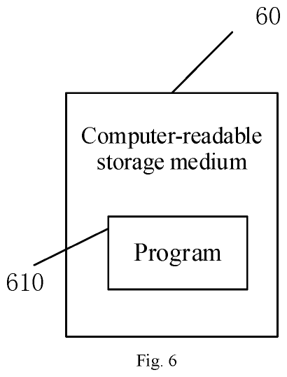

As shown in FIG. 6, an embodiment of the present disclosure provides a non-transitory computer-readable storage medium 60, in which one or more programs 610 are stored, and the one or more programs 610 can be executed by one or more processors, so that the one or more processors execute the steps of the method for implementing the machine learning engine described in any embodiment.

Compared with existing technologies, an embodiment of the present disclosure provides a device for realizing a machine learning engine, which includes a core learning application module with an independent application process and a prediction output service module located in a system process, where the core learning application module is configured to output a prediction result generated by machine learning to the prediction output service module; The prediction output service module is configured to buffer the prediction result when receiving the prediction result sent by the core learning application module. According to the technical scheme provided by this embodiment, by separating the prediction output from machine learning and placing the prediction output service module in the system process, the prediction result can be provided for other modules in the system process in real time and efficiently, and the user experience is improved.

It can be understood by those having ordinary skills in the art that all or some of the steps, systems and functional modules/units in the devices disclosed above can be implemented as software, firmware, hardware and appropriate combinations thereof. In the hardware implementation, the division between functional modules/units mentioned in the above description does not necessarily correspond to the division of physical components; For example, a physical component may have multiple functions, or a function or step may be cooperatively performed by several physical components. Some or all of the components may be implemented as software executed by a processor, such as a digital signal processor or a microprocessor, or as hardware, or as an integrated circuit, such as an application specific integrated circuit. Such software can be distributed on computer-readable medium, which can include transitory storage medium (or non-transitory storage medium) and communication medium. As well known to those having ordinary skills in the art, the term computer-readable storage medium includes volatile and nonvolatile, removable and non-removable medium implemented in any method or technology for storing information such as computer-readable instructions, data structures, program modules or other data. Computer-readable storage medium include but are not limited to RAM, ROM, EEPROM, flash memory or other memory technologies, CD-ROM, digital versatile disk (DVD) or other optical disk storage, magnetic boxes, magnetic tapes, magnetic disk storage or other magnetic storage devices, or any other medium that can be used to store desired information and can be accessed by computers. Furthermore, it is well known to those having ordinary skills in the art that communication medium typically contains computer-readable instructions, data structures, program modules, or other data in a modulated data signal such as a carrier wave or other transmission mechanism, and can include any information delivery medium.

1. An apparatus for implementing a machine learning engine, comprising:
a core learning application module with an independent application process; and
a prediction output service module located in a system process;
wherein the core learning application module is configured to output a prediction result generated by machine learning to the prediction output service module, and the prediction output service module is configured to buffer the prediction result in response to a reception of the prediction result sent by the core learning application module.

2. The apparatus for implementing a machine learning engine according to claim 1, wherein the core learning application module is further configured to perform machine learning to generate the prediction result.

3. The apparatus for implementing a machine learning engine according to claim 1, wherein the prediction output service module is further configured to return a buffered prediction result to other modules in the system process in response to a reception of a request for the prediction result from the other modules.

4. The apparatus for implementing a machine learning engine according to claim 3, wherein the prediction output service module is further configured to buffer a validity period of the prediction result; and to return the buffered prediction result to the other modules in response to a judgement that the prediction result is within the corresponding validity period.

5. The apparatus for implementing a machine learning engine according to claim 4, wherein the prediction output service module is further configured to obtain the validity period from the core learning application module, or to set the validity period independently.

6. The apparatus for implementing a machine learning engine according to claim 1, wherein:
the prediction output service module is further configured to send an update notification according to a preset policy to inform the core learning application module to perform a new machine learning operation; and
the core learning application module is further configured to start a new machine learning operation and output an updated prediction result to the prediction output service module after receiving the update notification from the prediction output service module.

7. The apparatus for implementing a machine learning engine according to claim 6, wherein the preset strategy comprises at least one of following: an expiration of a periodic interval, an occurrence of a preset event, or a detection of an expiration of the validity period of the buffered prediction result.

8. The apparatus for implementing a machine learning engine according to claim 4, wherein the prediction output service module is further configured to forcibly update the validity period of the prediction result or clear the prediction result, in response to an occurrence of a preset specific event.

9. A method for implementing a machine learning engine, comprising:
outputting, through a core learning application module with an independent application process, a prediction result generated by machine learning to a prediction output service module located in the system process; and
buffering the prediction result through the prediction output service module.

10. The method for implementing a machine learning engine according to claim 9, further comprising: in response to a reception of a request for the prediction result from other modules in the system process, returning the buffered prediction result to the other modules through the prediction output service module.

11. The method for implementing a machine learning engine according to claim 10, further comprising:
buffering a validity period of the prediction result by the prediction output service module;
wherein returning the buffered prediction result to the other modules comprises:
returning the buffered prediction result to the other modules in response to a judgement that the prediction result is within the corresponding validity period.

12. The method for implementing a machine learning engine according to claim 11, further comprising: obtaining the validity period from the core learning application module, or independently setting the validity period, through the prediction output service module.

13. The method for implementing a machine learning engine according to claim 9, further comprising:
sending an update notification through the prediction output service module according to a preset strategy to inform the core learning application module to perform a new machine learning operation; and
starting the new machine learning operation and outputting an updated prediction result to the prediction output service module, by the core learning application module, in response to a reception of the update notification from the prediction output service module.

14. The method for implementing a machine learning engine according to claim 13, wherein the preset strategy comprises at least one of following: an expiration of a periodic interval, an occurrence of a preset event, or a detection of an expiration of the validity period of the buffered prediction result.

15. The method for implementing a machine learning engine according to claim 11, wherein the method further comprises: updating the validity period of the prediction result forcibly or clear the prediction result, through the prediction output service module, in response to an occurrence of a preset specific event.

16. (canceled)

17. A non-transitory computer-readable storage medium storing at least one program, wherein the at least one program is executable by at least one processor and cause the at least one processor to perform a method for implementing a machine learning engine comprising:
outputting, through a core learning application module with an independent application process, a prediction result generated by machine learning to a prediction output service module located in the system process; and
buffering the prediction result through the prediction output service module.
